(19) United States
(12) Patent Application Publication
(10) Pub. No.: US 2026/0055931 A1
(43) Pub. Date: Feb. 26, 2026

(54) SYSTEMS AND METHODS FOR PROVIDING AN EMERGENCY SUPPLY OF WATER WITHIN A DWELLING

(71) Applicant: Shahar ARYE, Tenuvot (IL)

(72) Inventor: Shahar ARYE, Tenuvot (IL)

(21) Appl. No.: 19/371,740

(22) Filed: Oct. 28, 2025

Related U.S. Application Data
(63) Continuation-in-part of application No. PCT/IB2024/054174, filed on Apr. 30, 2024.

(30) Foreign Application Priority Data
May 1, 2023 (IL) 302572

(51) Int. Cl. F24S 20/60; F24S 10/70

(52) U.S. Cl. CPC F24S 20/60; F24S 10/70

(57) ABSTRACT

A hot water heating system of a dwelling includes a storage tank and a hot water pipe that collects water from a relative upper portion of the storage tank. This water is fed towards a hot water distribution network of the dwelling. The hot water heating system includes in addition a cross-connection pipe that is activated during an emergency mode of the system to direct water from a relative lower portion of the storage tank to be supplied to occupants of the dwelling via the hot water distribution network of the dwelling.

### TECHNICAL FIELD

Embodiments of the invention relate to systems and methods for providing an emergency supply of water within a dwelling, in particular based on existing water sources of the dwelling.

### BACKGROUND

A dwelling, such as a residential house, normally includes several types of water reservoirs for domestic use. A hot water tank for example is typically connected to a heating system, such as a boiler or a solar water heating system (or the like).

Various types of solar water heating systems exist, such as passive type systems that typically include of a collector that is usually located on the roof of a building together with a storage tank or reservoir. The collector is made up of one or more panels or tubes that are designed to absorb solar energy and convert it into heat. The heat absorbed by the collector is transferred to a fluid, usually water, which flows through the collector via natural convection towards the storage tank that is usually located above the collector. As the heated fluid enters the tank, it displaces cooler water, which flows back down to the collector to be reheated.

Hot water is collected from a relative upper portion of the storage tank to be made available for use via a hot water distribution system of the dwelling, which is designed to carry hot water towards fixtures within the house that require it, such as sinks, showers, washing machines (and the like).

The hot water storage tank is typically supplied with cold water to replace the hot water that has been used. This process of refilling or replenishing the tank is performed via the cold water distribution system, which is designed to carry cold water from the main water supply to the fixtures and appliances that require cold water throughout the house.

The refilling or replenishing of the hot water storage tank is typically performed via an inlet for the cold water that is located at a relative lower side of the storage tank.

### SUMMARY

The following embodiments and aspects thereof are described and illustrated in conjunction with systems, tools and methods which are meant to be exemplary and illustrative, not limiting in scope.

In a broad aspect of the present invention, disclosed herein are solutions for providing water during an emergency situation to occupants of a dwelling, such as a residential house, an office building, a commercial building (or the like).

In most embodiments, the proposed solution comprises diverting water out of a lower section of a storage system of the hot water system of the dwelling towards an already existing hot water distribution network of the dwelling.

In certain cases, a hot water system of a dwelling may be integrally designed with such an emergency functionality of providing water to occupants of the dwelling during an emergency.

In certain cases, an already existing hot water system of a dwelling may be retrofitted after or during installation in the dwelling to function also for providing water to occupants of the dwelling during an emergency.

Hot water systems integrally fitted with such an emergency functionality or modified for providing water to occupants of a dwelling during an emergency may be of various types, such as system that are assisted by solar collectors for heating the hot water, system that mostly or exclusively heat the water by other means such as electricity (or the like).

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a partial view of typical hot water heating system of a dwelling; and

FIGS. 2 to 15 schematically show hot water heating systems in accordance with various other embodiments of the present invention that are suited for supplying water within the dwelling during an emergency.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

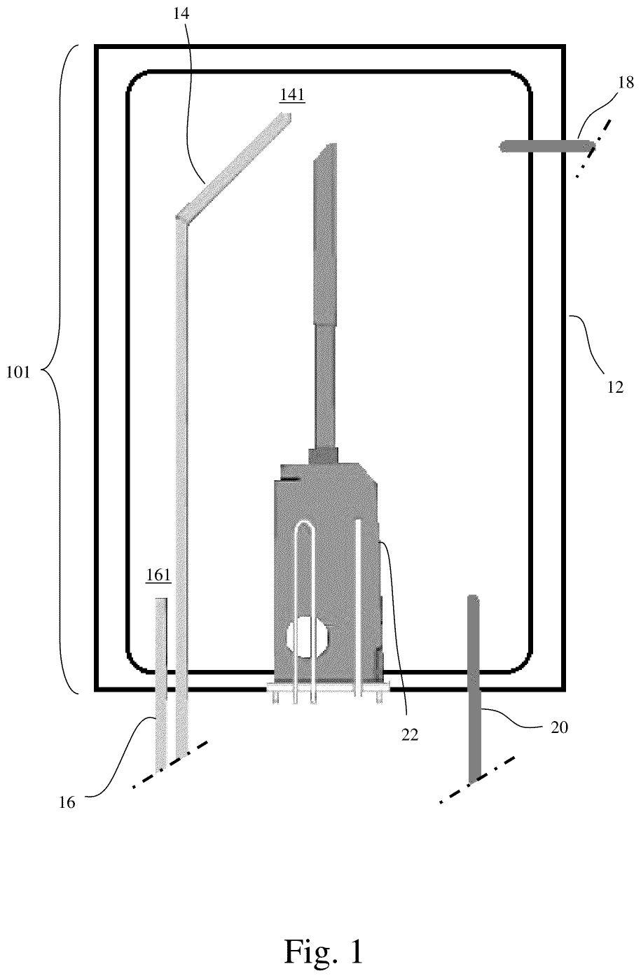

Attention is first drawn to FIG. 1 schematically showing a partial view of a typical hot water heating system 101 of a dwelling. The system 101 here can be seen including a storage tank 12 for making hot water available for use via a hot water distribution network of the dwelling. A hot water pipe 14 collects hot water, via an outlet 141 that is located at a relative upper portion of the storage tank, to feed the hot water distribution network of the dwelling. A cold water pipe 16 refills the storage tank, via an inlet 161 that is located at a relative lower side of the storage tank, with cold water from a cold water distribution network of the dwelling.

In this example, the heating system 101 if of a type that includes a collector (not seen) that is designed to absorb solar energy and convert it into heat. An incoming pipe 18 leads hot water from the collector towards an upper portion of the storage tank 12 to displace cooler water that flows downwards and outwards via an outgoing pipe 20 to be reheated at the collector. In this example, an electric heating element 22 is included in the water heating system as a supplement to the solar collector.

A cold water distribution network, which is designed to carry cold water from a main water supply to fixtures and appliances throughout a dwelling—in times of an emergency (e.g. due to electrical power outage due to an earthquake, war or the like), may cease to function resulting in lack of water supply to occupants of the dwelling.

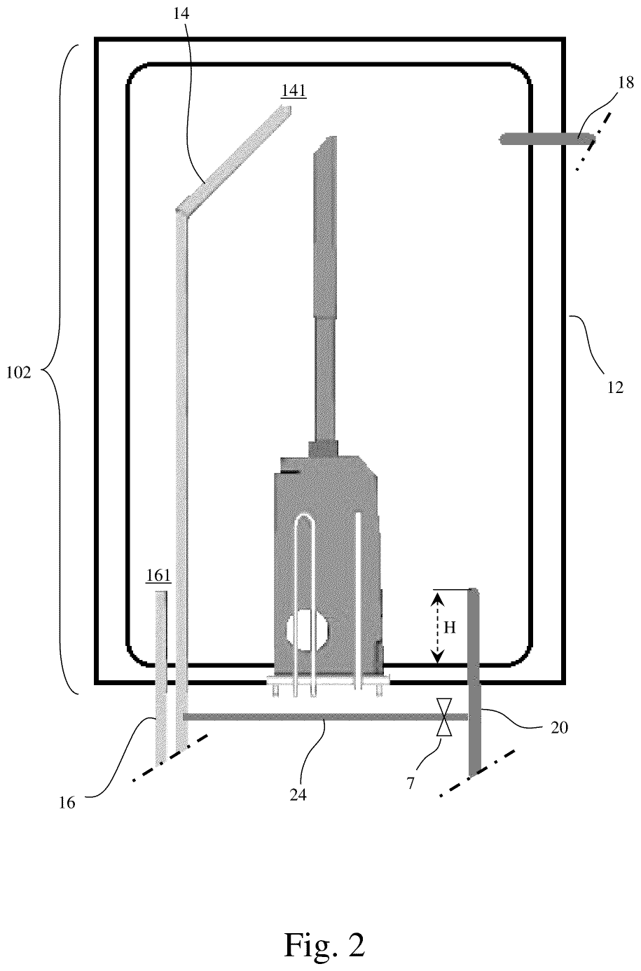

Attention is drawn to FIG. 2 schematically showing a hot water heating system 102 in accordance with an embodiment of the present invention that is suited for supplying water within the dwelling during an emergency.

Hot water heating system 102 is generally similar to system 101 seen in FIG. 1, however here includes a cross-connection pipe 24 that connects between outgoing pipe 20 and hot water pipe 14. A valve 7 is located along cross-connection pipe 24 and can be controlled to open or close liquid communication via cross-connection pipe 24 between outgoing pipe 20 and hot water pipe 14.

In accordance with various embodiments of the invention, it is noted that valves (such as valve 7, 71, 72 etc.) may be electrically powered for their operation, and preferably may be designed to operate on a relative low supply voltage of about 12-24 VDC-so that during an emergency situation when e.g. there is an electrical power shut down-they may operate on electricity supplied from batteries. In some examples, one or more or all of the valves (such as valve 7, 71, 72 etc.) used for transitioning a hot water system into its emergency mode—may be manually operated —so that e.g. during a power outage the transition to the emergency mode may be easily performed.

In accordance with various embodiments of the invention, it is noted that batteries used for powering elements relating to the emergency operation of a hot water system, may be rechargeable so that they are ready function during power outage. In some cases, charging of batteries may be from various sources, such as from photovoltaic cells that convert sunlight directly into electrical energy.

During an emergency, valve 7 may be opened to allow water stored within storage tank 12 to exit a relative lower side of the storage tank in this example via outgoing pipe 20 that during normal operation of heating system 102 directs water from the lower side of the storage tank towards the solar collectors.

When valve 7 is opened, instead of flowing towards the solar collectors, the water is directed to flow towards hot water pipe 14 and from there onwards towards the hot water distribution network of the dwelling. As a result, occupants of the dwelling may gain access to water during such time of an emergency via fixtures within the dwelling that are connected to the hot water distribution network. For example, the water may be available via the hot water tap that is connected to the hot water distribution network.

With attention drawn to the example in FIG. 2 it is seen that while a height of the internal storage volume of the storage tank is relative high and e.g. outlet 141 of the hot water pipe collects water from a relative upper side of the storage tank-conventional existing pipes in a hot water system that typically lead colder water out of the storage tank, such as outgoing pipe 20, do so from a relative lower side of the tank's internal volume, which is here marked as having a height ‘H’ above the lower side of the storage tank.

Height ‘H’ may be typically chosen to be small as possible in order to utilize as much water as possible from the storage tank, while limiting the likelihood of sediment at the bottom of the storage tank from flowing out of the storage tank and blocking flow channels within the hot water system.

In a broad aspect of the present invention, pipes supplying water towards occupants of a dwelling during an emergency are designed to collect water from a relative lower side of the storage tank in order to utilize as much water as possible from the storage tank. Typically, height ‘H’ may be at about 10 centimeters or less (e.g. about 5 centimeters) above the lower side of the storage tank, and hence in various embodiments of the present disclosure, pipes leading water out of the storage tank towards occupants of a dwelling during an emergency are designed to collect water from a height ‘h’ that is generally equal to ‘H’.

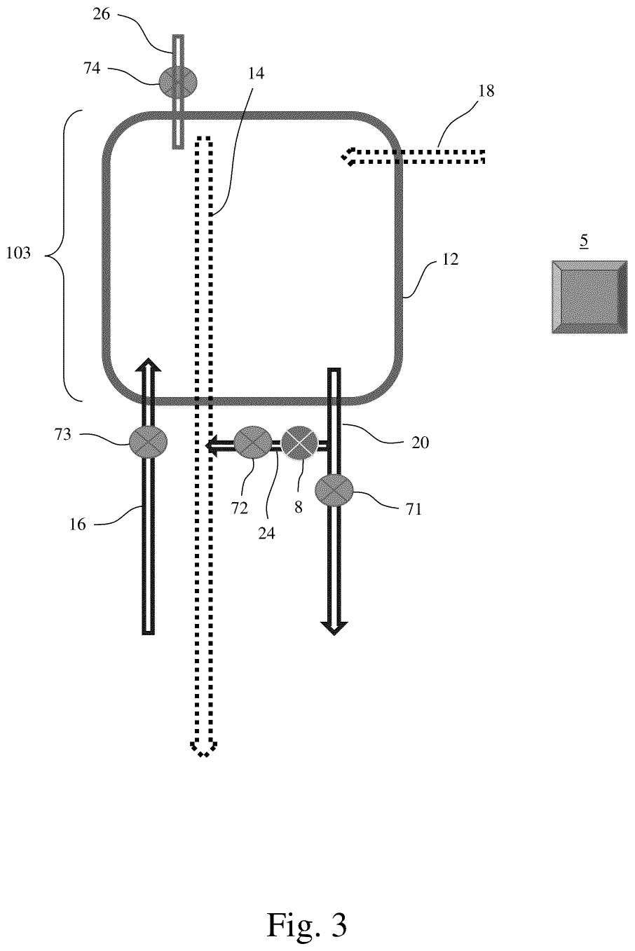

Attention is drawn to FIG. 3 schematically showing a hot water heating system 103 in accordance with an embodiment of the present invention that is suited for supplying water within the dwelling during an emergency.

Hot water heating system 103 is generally similar to system 102 seen in FIG. 2 by including a cross-connection pipe 24 that connects between outgoing pipe 20 and hot water pipe 14.

In this example, a first valve 71 may be located along outgoing pipe 20 at a location downstream to where it branches off to cross-connection pipe 24, in order to open or close flow towards the solar collectors.

A second valve 72 may be located along cross-connection pipe 24 to open or close flow along cross-connection pipe 24, and a temperature sensor 8 may be also located along cross-connection pipe 24 to sense the temperature of water exiting the storage tank during an emergency towards hot water pipe 14.

A third valve 73 may be located along cold water pipe 16 to open or close flow along this pipe 16, and system 103 may include an air intake pipe 26 for allowing air entry into storage tank 12 in order to prevent negative pressure within the storage tank 12 and improve water flow of the storage tank. A fourth valve 74 may be located at air intake pipe 26 to open or close air flow into storage tank 12.

It is noted that a valve located along the cold water pipe 16 (such as third valve 73 seen in FIG. 3) may be activated during an emergency mode to close the passage along the cold water pipe for back flow of water out of the storage tank along this route. Such back flow of water via the cold water pipe may occur e.g. in case of a drop in pressure in pipe 16 and the cold water distribution network of the dwelling. Such drop in pressure may be due to breaches in the piping providing water towards the dwelling from the street (and the like).

An activation switch 5 may be provided in this example in communication with the valves 71, 72, 73, 74 and sensor 8 in order to control provision of water during an emergency to occupants of the dwelling, in this example out of a relative lower side of the storage tank 12 via outgoing pipe 20 and towards fixtures of the dwelling connected to the hot water distribution network of the dwelling via hot water pipe 14.

It is noted that in the various embodiments here disclosed, activation switch 5 may be located in various locations of the dwelling, such as within the dwelling as part of the switch powering electrical current towards e.g. electric heating element 22, at any other location within the dwelling such as on the roof of the dwelling (etc.). Activations switch 5 in accordance with the various embodiments may be powered by electrical power of the dwelling or by batteries, possibly rechargeable batteries.

With attention drawn back to the embodiment of water heating system 103 it is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Activation switch 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

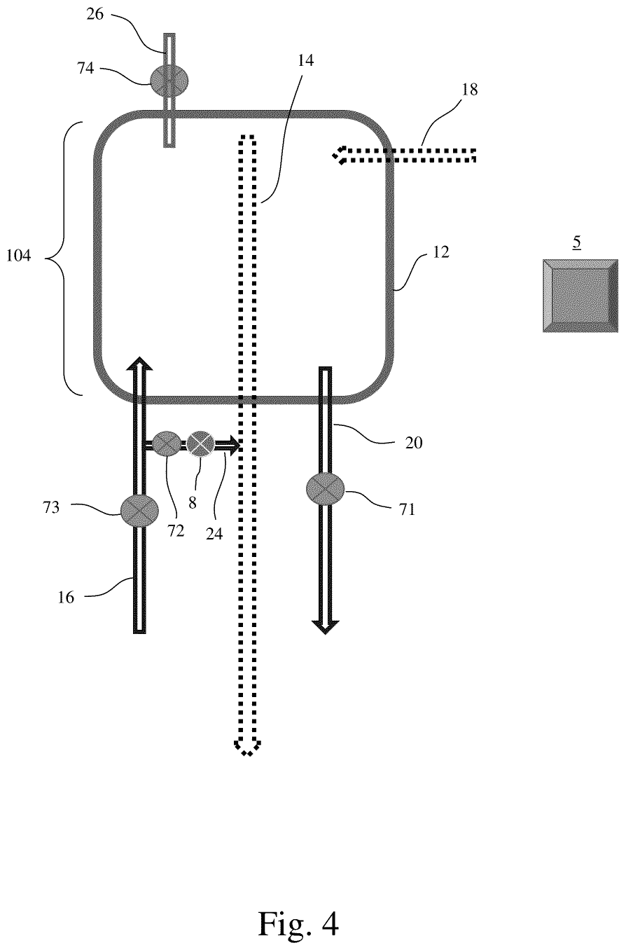

Attention is drawn to FIG. 4 schematically showing a hot water heating system 104 in accordance with an embodiment of the present invention that is suited for supplying water within the dwelling during an emergency.

Hot water heating system 104 is generally similar to system 103 seen in FIG. 3, however in this example includes a cross-connection pipe 24 that connects between cold water pipe 16 and hot water pipe 14.

In this example, a first valve 71 may be located along outgoing pipe 20 in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side in this example via the cold water pipe 16 during an emergency towards hot water pipe 14.

A third valve 73 may be located along cold water pipe 16 at a location that is below (e.g. upstream during normal flow of cold water towards the tank) to where cross-connection pipe 24 branches off in this example.

System 104 may include an air intake pipe 26 for allowing air entry into storage tank 12 in order to prevent negative pressure within storage tank 12 and improve water flow of the storage tank. A fourth valve 74 may be located at air intake pipe 26 to open or close air flow into storage tank 12.

An activation switch 5 may be provided in communication with the valves 71, 72, 73, 74 and sensor 8 in order to control provision of water during an emergency 20) to occupants of the dwelling, in this example out of a relative lower side of the storage tank 12 via cold water pipe 16 and towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

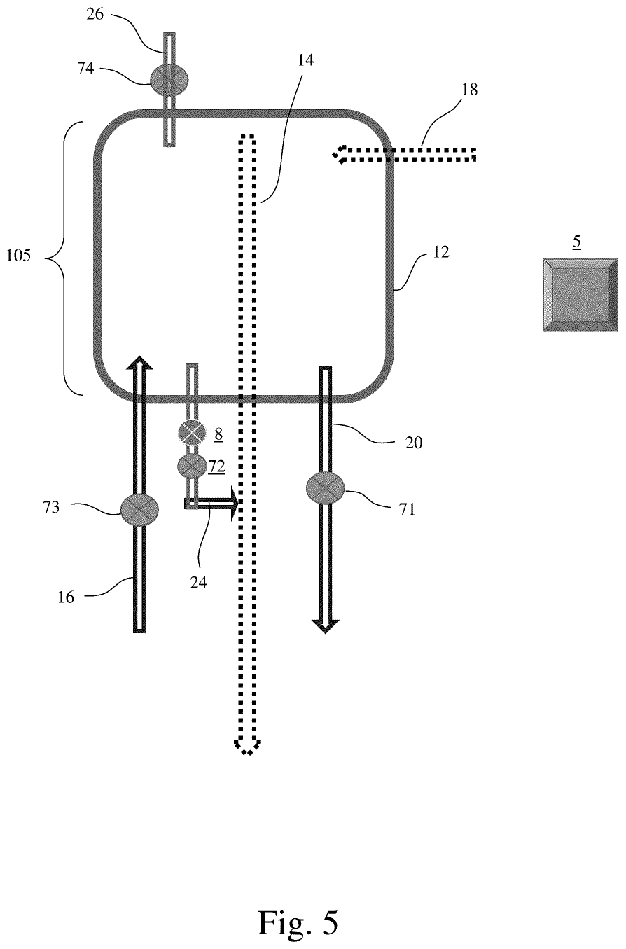

Attention is drawn to FIG. 5 schematically showing a hot water heating system 105 in accordance with an embodiment of the present invention that is suited for supplying water within the dwelling during an emergency.

Hot water heating system 105 is generally similar to system 104 seen in FIG. 4, however in this example includes a cross-connection pipe 24 that directly connects a lower side of storage tank 12 to hot water pipe 14.

In this example, a first valve 71 may be located along outgoing pipe 20 in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side during an emergency towards hot water pipe 14. A third valve 73 may be located along cold water pipe 16.

System 105 may include an air intake pipe 26 for allowing air entry into storage tank 12 in order to prevent negative pressure within storage tank 12 and improve water flow of the storage tank. A fourth valve 74 may be located at air intake pipe 26 to open or close air flow into storage tank 12.

An activation switch 5 may be provided in communication with the valves 71, 72, 73, 74 and sensor 8 in order to control provision of water during an emergency 20) to occupants of the dwelling, in this example out of a relative lower side of the storage tank 12 towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

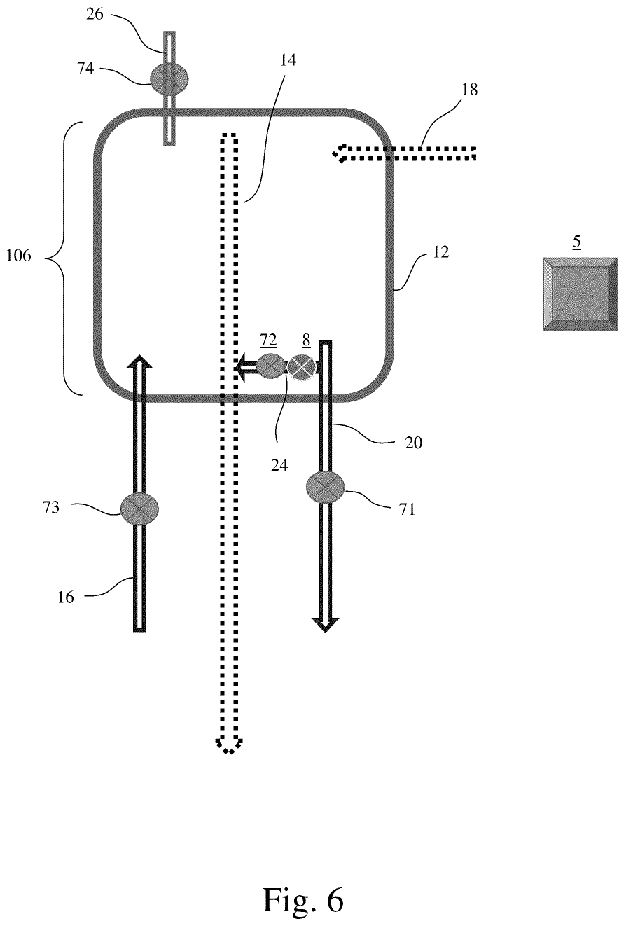

Attention is drawn to FIG. 6 schematically showing a hot water heating system 106 in accordance with an embodiment of the present invention that is suited for supplying water within the dwelling during an emergency.

Hot water heating system 106 is generally similar to system 105 seen in FIG. 4, however in this example includes a cross-connection pipe 24 that connects between an upstream side of outgoing pipe 20 within storage tank and a section of hot water pipe 14 that is still within the storage tank.

In this example, a first valve 71 may be located along outgoing pipe 20 in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side during an emergency towards hot water pipe 14. A third valve 73 may be located along cold water pipe 16.

System 106 may include an air intake pipe 26 for allowing air entry into storage tank 12 in order to prevent negative pressure within storage tank 12 and improve water flow of the storage tank. A fourth valve 74 may be located at air intake pipe 26 to open or close air flow into storage tank 12.

An activation switch 5 may be provided in communication with the valves 71, 72, 73, 74 and sensor 8 in order to control provision of water during an emergency to occupants of the dwelling, in this example out of a relative lower side of the storage tank 12 towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

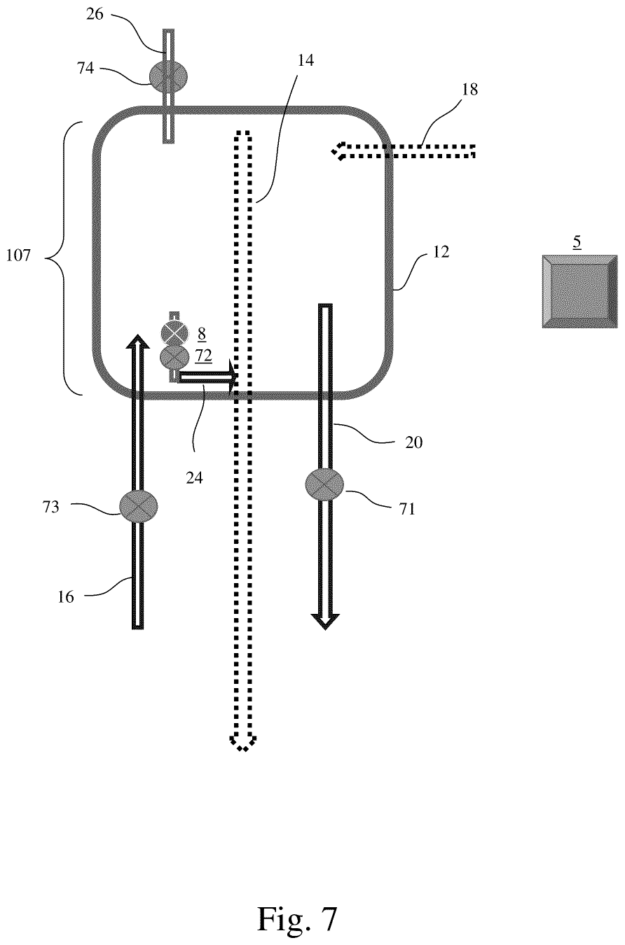

Attention is drawn to FIG. 7 schematically showing a hot water heating system 107 in accordance with an embodiment of the present invention that is suited for supplying water within the dwelling during an emergency.

Hot water heating system 107 is generally similar to system 106 seen in FIG. 6, however in this example includes a cross-connection pipe 24 located within the storage tank that connects a lower side of the storage tank to a section of hot water pipe 14 that is still within the storage tank.

In this example, a first valve 71 may be located along outgoing pipe 20 in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side during an emergency towards hot water pipe 14. A third valve 73 may be located along cold water pipe 16.

System 107 may include an air intake pipe 26 for allowing air entry into storage tank 12 in order to prevent negative pressure within storage tank 12 and improve water flow of the storage tank. A fourth valve 74 may be located at air intake pipe 26 to open or close air flow into storage tank 12.

An activation switch 5 may be provided in communication with the valves 71, 72, 73, 74 and sensor 8 in order to control provision of water during an emergency to occupants of the dwelling, in this example out of a relative lower side of the storage tank 12 towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

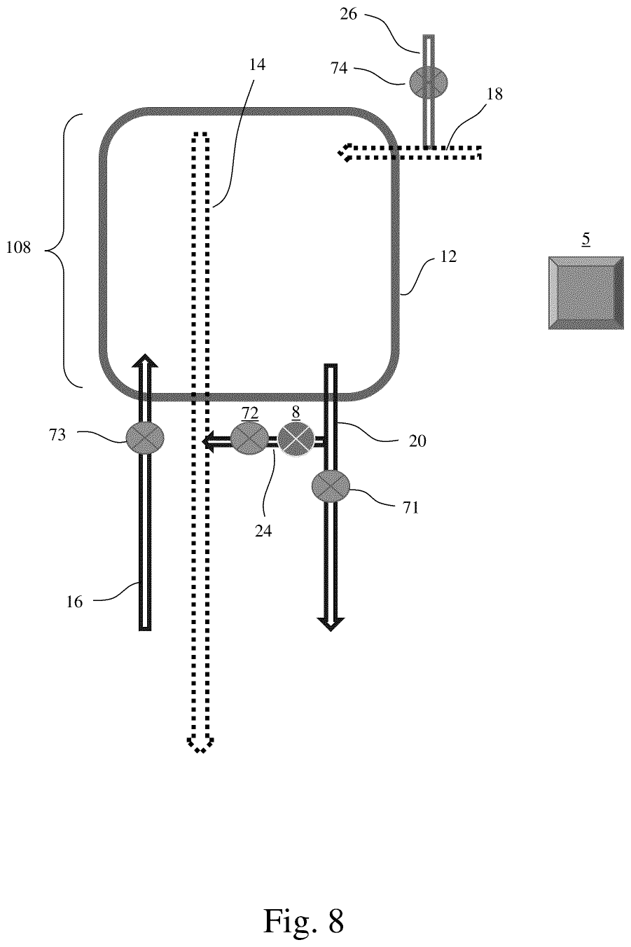

Attention is drawn to FIG. 8 schematically showing a hot water heating system 108 in accordance with an embodiment of the present invention that is suited for supplying water within the dwelling during an emergency.

Hot water heating system 108 is generally similar to system 107 seen in FIG. 7, however in this example includes a cross-connection pipe 24 located between outgoing pipe 20 and hot water pipe 14.

In this example, a first valve 71 may be located along outgoing pipe 20 at a position downstream to where cross-connection pipe 24 branches off in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side during an emergency towards hot water pipe 14. A third valve 73 may be located along cold water pipe 16.

System 108 may include an air intake pipe 26 for allowing air entry into storage tank 12 in order to prevent negative pressure within storage tank 12 and improve water flow of the storage tank. In this example, intake pipe 26 communicates with the storage tank via incoming pipe 18. A fourth valve 74 may be located at air intake pipe 26 to open or close air flow towards storage tank 12 accordingly via incoming pipe 18.

An activation switch 5 may be provided in communication with the valves 71, 72, 73, 74 and sensor 8 in order to control provision of water during an emergency to occupants of the dwelling, in this example out of a relative lower side of the storage tank 12 towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74 and sensor 8 may be electrically powered and/or powered by a battery. In addition, in various embodiments, not all valves and the sensor may be used but only one or more may be used according to design and other (such as energy efficiency) considerations.

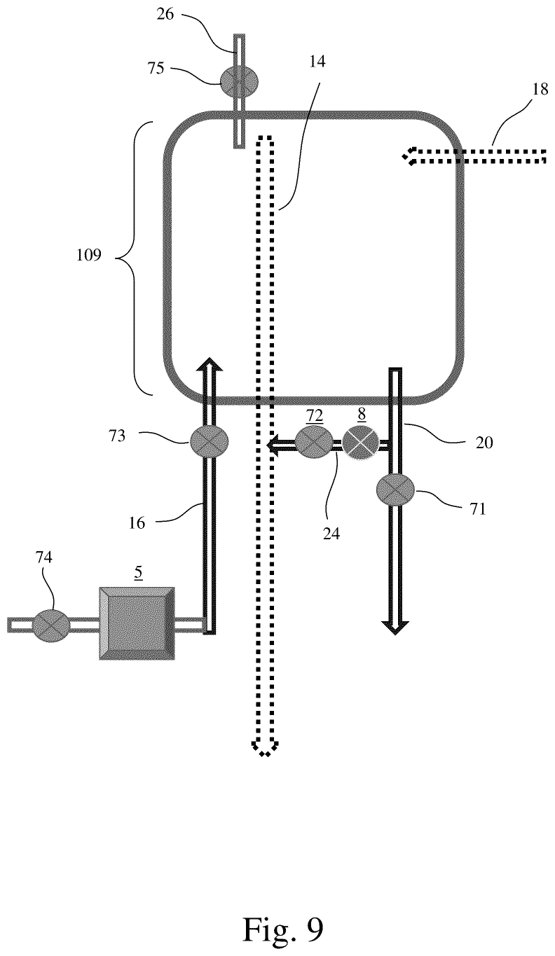

Attention is drawn to FIG. 9 schematically showing a hot water heating system 109 in accordance with an embodiment of the present invention that is suited for supplying water within the dwelling during an emergency.

Hot water heating system 109 is generally similar to system 108 seen in FIG. 8 and again includes a cross-connection pipe 24 located between outgoing pipe 20 and hot water pipe 14.

In this example, a first valve 71 may be located along outgoing pipe 20 at a position downstream to where cross-connection pipe 24 branches off in order to open or close flow towards the solar collectors.

A second valve 72 may be located along cross-connection pipe 24 to open or close flow along pipe 24, and a temperature sensor 8 may be also located along cross-connection pipe 24 to sense the temperature of water exiting the storage tank from its lower side during an emergency towards hot water pipe 14.

A third valve 73 may be located along cold water pipe 16 in this example at a location close to where in communicates with the tank. A fourth valve 74 may be located more distant from the water tank 12 and an activation switch 5 may be positioned in between the valves 73, 74 along cold water pipe 16.

In this example, fourth valve 74 may be a pressure switch that monitors and controls pressure levels along cold water pipe 16. It may feature an adjustable set point and a switching output, which can be used for activating activation switch 5 to transition the hot water heating system to an emergency state upon detection of a drop in pressure along cold water pipe 16 that may be indicative of an emergency situation.

System 109 may include an air intake pipe 26 for allowing air entry into storage tank 12 in order to prevent negative pressure within storage tank 12 and improve water flow of the storage tank. A fifth valve 75 may be located at air intake pipe 26 to open or close air flow towards storage tank 12.

An activation switch 5 may be provided in communication with the valves 71, 72, 73, 74, 75 and sensor 8 in order to control provision of water during an emergency to occupants of the dwelling, in this example out of a relative lower side of the storage tank 12 towards fixtures of the dwelling connected to the hot water distribution network of the dwelling via hot water pipe 14.

It is noted that sensor 8 may assist in ensuring the temperature of the water that is supplied to the occupants of the dwelling during an emergency, to avoid thermal burn e.g. to the mouth, tongue, throat, skin or other tissues of an occupant of the dwelling in the case that the water being supplied is too hot.

Controller 5, valves 71, 72, 73, 74, 75 and sensor 8 may be electrically powered and/or powered by a battery. In addition, in various embodiments, not all valves and the sensor may be used but only one or more may be used according to design and other (such as energy efficiency) considerations.

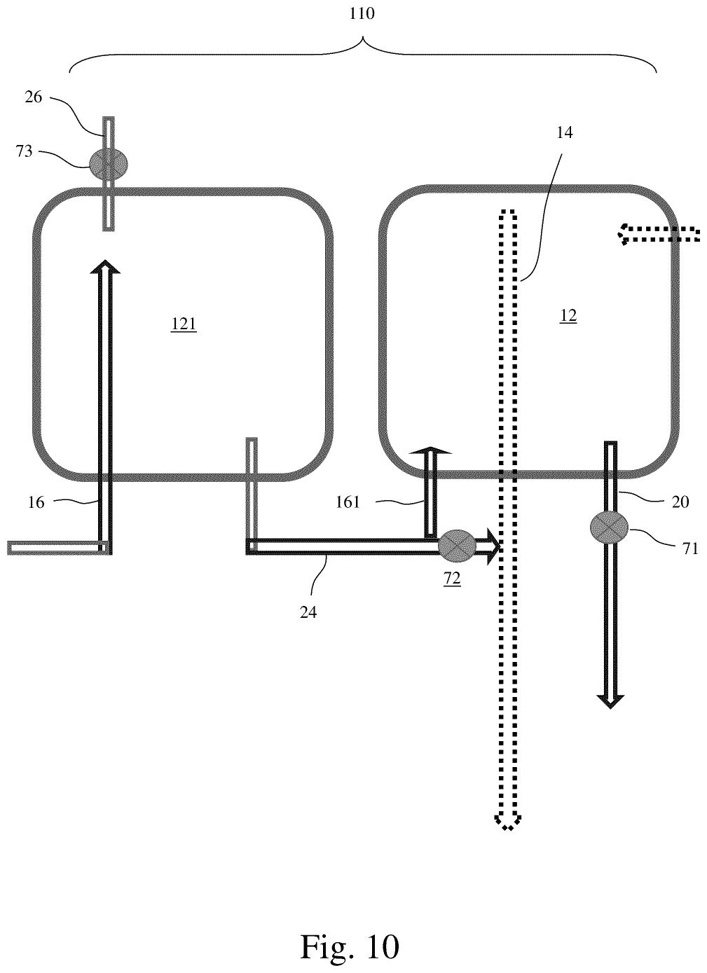

Attention is drawn to FIG. 10 schematically showing a hot water heating system 110 in accordance with an embodiment of the present invention that is suited for supplying water within the dwelling during an emergency.

Hot water heating system 110 in this example includes primary 12 and secondary 121 storage tanks. Secondary storage tank 121 provides an additional buffer of water that may be supplied during an emergency to occupants of the dwelling, and as seen the air intake pipe 26 and a valve 73 may be connected to the secondary storage tank.

A cross-connection pipe 24 as seen may communicate water out of secondary storage tank 121 towards the hot water pipe 14 that exits primary storage tank 12. A valve 72 may be positioned adjacent to a location where cross-connection pipe 24 and hot water pipe 14 meet.

A cold water pipe 16 of the cold water distribution network of the dwelling having an outlet at a relative upper side of the secondary storage tank may communicate with secondary storage tank 121 to refill it and cross-connection pipe 24 may have a branch that communicates with primary storage tank 12 to refill it with water arriving from secondary water tank 121.

Positioning the outlet of cold water pipe 16 at a relative upper side of secondary storage tank 121 may assist in ensuring that water entering secondary storage tank 121 will not flow back down via cold water pipe 16 in case of a drop in pressure in pipe 16 and the cold water distribution network of the dwelling.

In this embodiment, an increased volume of water may be supplied to occupants of the dwelling due to the additional storage tank that is provided.

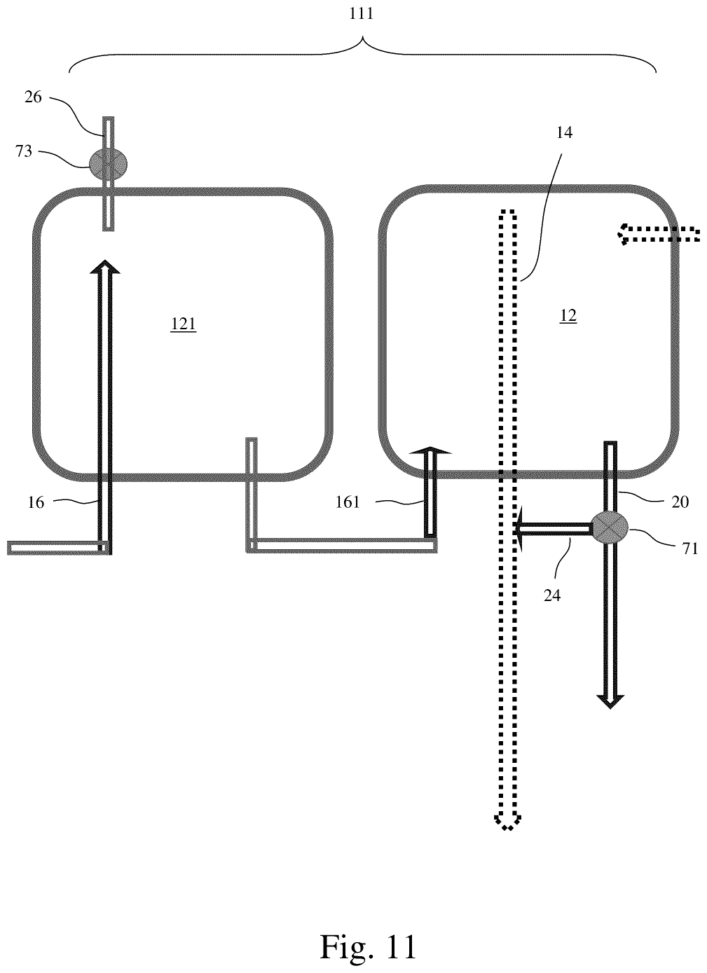

The hot water heating system 111 of FIG. 11 is generally similar to system 110 in FIG. 10, however with the cross-connection pipe 24 connecting in this example between outgoing pipe 20 and hot water pipe 14.

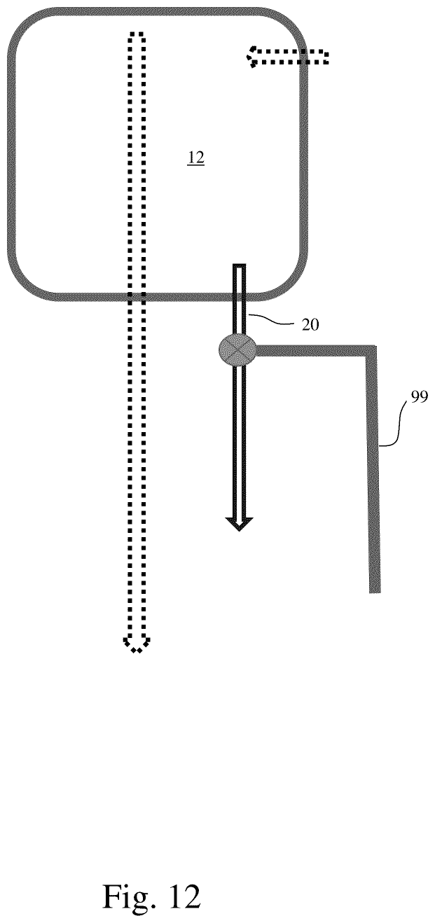

FIG. 12 shows an embodiment where dwelling dedicated pipe 99 may be used for transferring water out of a lower level of the storage take 12, in this example via outgoing pipe 20 down towards a location where occupants of the dwelling can gain access to water during an emergency.

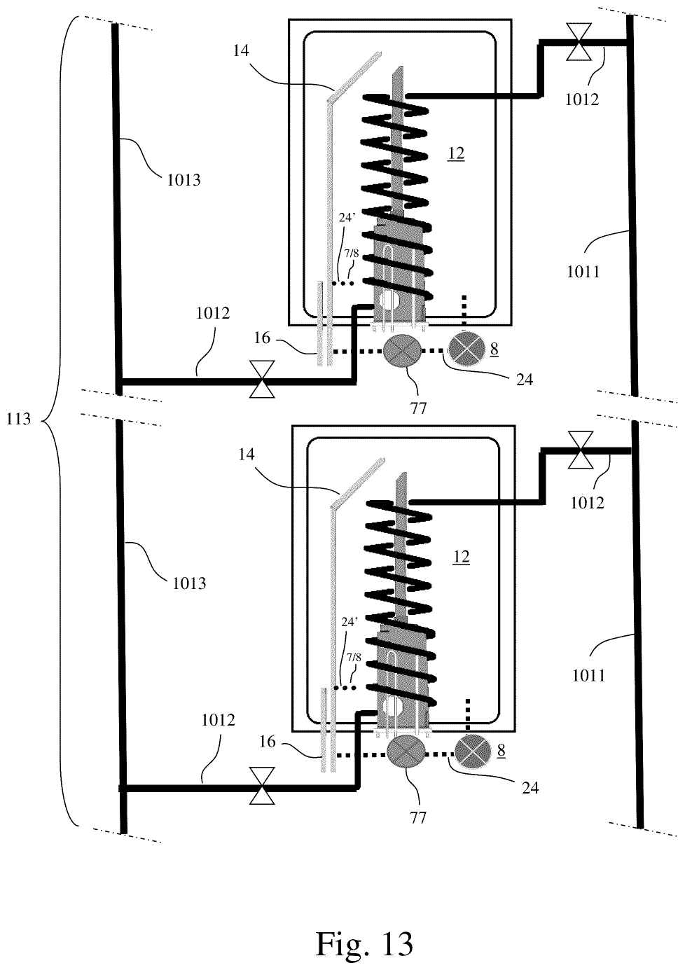

Attention is drawn to FIG. 13 schematically showing a partial view of a hot water heating system 113 of a multi-story dwelling in accordance with an embodiment of the present invention that is suited to supply water within the dwelling during an emergency.

Hot water heating system 113 is seen including in this example a hot water main pipe 1011 that leads hot water downwards possibly from solar collectors located on a roof of the dwelling. Heating pipes 1012 branching off from main pipe 1011 spirally pass through storage tanks 12 at each floor of the multi-story dwelling, to heat the water within each storage tank in this example without mixing with water in the storage tank.

The now more cooler water exits each storage tank via a downstream section of pipe 1012 to merge into a cold water main pipe 1013 that leads the water back up possibly to the roof of the dwelling to be reheated and flow back downwards via hot water main pipe 1011.

In this example, a cold water pipe 16 is seen refilling each storage tank 12 with water from a cold water distribution network of the dwelling. A hot water pipe 14 collects hot water, via an outlet that is located at a relative upper portion of the storage tank, to feed the hot water distribution network servicing each floor of the dwelling.

In the example of water heating system 113, a cross-connection pipe 24 is implemented to direct water out of a lower region of each storage tank upon opening of a valve 77 that is located along each pipe 24. Possibly, a temperature sensor 8 may also be located along the cross-connection pipe 24 to monitor the temperature of water being supplied to the occupants of the dwelling during an emergency. This water that may be activated to flow during an emergency towards the hot water pipe 14 of each storage tank and from there onwards towards the hot water distribution network servicing each floor of the dwelling. An alternative option of a cross-connection pipe, which may be implemented in this embodiment—can be seen being marked as 24′ and may be used for directing water from within the storage tank to a section of the hot water pipe 14 that is located within the storage tank. As seen, a valve 7 and a temperature sensor 8 may also be positioned along this option of the cross-connection pipe 24′.

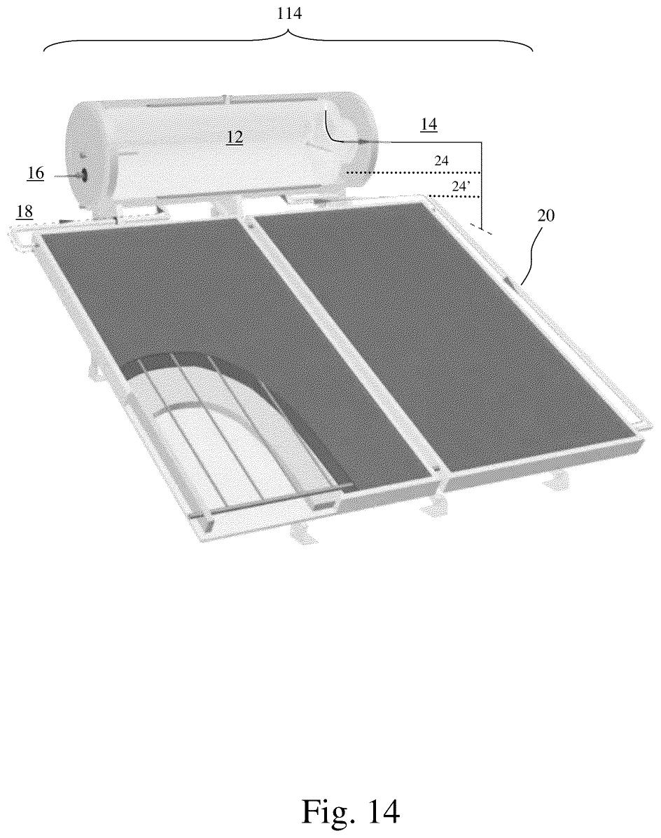

Attention is drawn to FIG. 14 showing a hot water system 114 in this example having a relative horizontally extending storage tank 12. As in the previous examples, a cross-connecting pipe 24 can here too be used for connecting either directly from within a relative lower side of the storage tank to hot water pipe 14, or alternatively between outgoing pipe 20 and hot water pipe 14—in order to supply water to occupants of a dwelling during an emergency. Even though not indicated, here too valves and possibly a temperature sensor may be used for controlling the flow of water towards the occupants of the dwelling during an emergency.

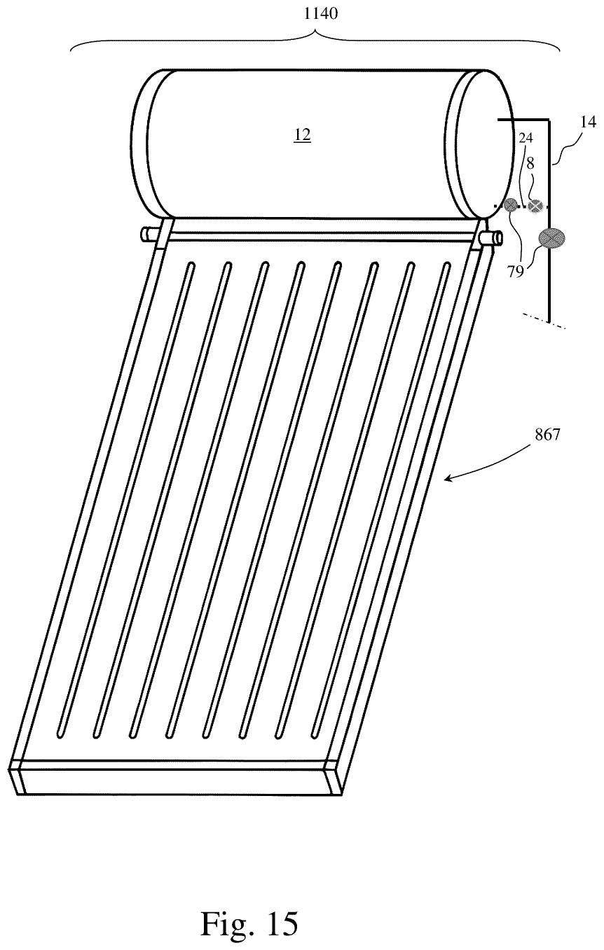

Attention is drawn to FIG. 15 showing an embodiment of a hot water system 1140 according to the present invention. Hot water system 1140 is of a photovoltaic (PV) water type heater that uses a solar panel 867 to produce electricity, which powers an electric heating element inside a water tank 12.

In this example (as also illustrated in the embodiment of FIG. 14), the water tank 12 is shown in a “horizontal” orientation. However, it should be noted that the various embodiments of the invention are applicable to both “horizontally” and “vertically” oriented water tanks (as illustrated in most other embodiments of the disclosure). In any case, systems including either “horizontally” or “vertically” oriented water tanks—may be designed so that their cross-connecting pipes 24 communicate with the lower side of the tank to enable a maximum supply of water during an emergency to occupants of a dwelling where such a system is installed.

Attention is drawn back to FIG. 15. Unlike traditional solar thermal systems (such as the one seen in FIG. 14) that rely on circulating fluids through solar collectors, in FIG. 15 the setup heats water using electricity generated directly from sunlight using photovoltaic cells located within its solar panel 867.

A cross-connecting pipe 24 may accordingly be used to link the lower section of the storage tank 12 to the system's hot water pipe 14, allowing water to be supplied to occupants during emergencies. To prevent continued heating of the water in the storage tank 12, the electrical energy generated by the PV solar panel 867 may be blocked from reaching the heating element in case of an emergency. Additionally, a temperature sensor 8 and valves 79 may be employed to regulate water flow to the occupants during emergency situations out of the water tank via the cross-connecting pipe 24.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A hot water heating system of a dwelling, said hot water system comprising a solar collector, a hot water distribution network, a storage tank and a hot water pipe for collecting water from a relative upper portion of the storage tank to feed said hot water distribution network, wherein
the hot water heating system comprising a cross-connection pipe that is activated during an emergency mode of the system to direct water from a relative lower portion of the storage tank to be supplied to occupants of the dwelling via the hot water distribution network, wherein
during an emergency mode of the system operation of the solar collector is suspended to prevent further heating of the water in the storage tank, which would otherwise continue as long as solar radiation reaches the collector.

2. The hot water heating system of claim 1, wherein the solar collector comprises photovoltaic cells for generating electricity from solar radiation incident on the collector, and the heating of the water in the storage tank is carried out via an electrically activated heating element, and wherein suspending operation of the solar collector comprises shutting off electricity generated by the collar collector from reaching the heating element.

3. The hot water heating system of claim 1, wherein the system further comprises an outgoing pipe for drawing water from a lower portion of the storage tank towards the solar collector, and water heating is driven by natural convection that circulates water from the tank to the collector and back to the tank, and wherein suspending operation of the solar collector comprises shutting off flow of water through the outgoing pipe towards the solar collector.

4. The hot water heating system of claim 2, wherein the hot water heating system further comprising an air intake pipe, a cold water pipe and at least one temperature sensor, wherein
the air intake pipe being activated during the emergency mode of the system to open and allow air entry into the storage tank in order to prevent negative pressure within the storage tank, and wherein
the cold water pipe being for refilling the storage tank and comprising a valve that is activated during the emergency mode of the system to close in order to prevent back flow of water via the cold water pipe, and wherein
the at least one sensor being located along the flow path of water exiting the storage tank towards and passed the cross-connection pipe during the emergency mode of the system in order to sense the temperature of the water supplied to the occupants of the dwelling.

5. The hot water heating system of claim 4, wherein the cross connection pipe comprising a second valve located along said cross-connection pipe in order to limit and/or shut off flow of water passed the cross-connection pipe in response to sensed temperature that is above a certain threshold.

6. The hot water heating system of claim 1, wherein the cross-connection pipe is located outside of the storage tank.

7. The hot water heating system of claim 1, wherein the cross-connection pipe is located within the storage tank.

8. The hot water heating system of claim 1, wherein activation of the emergency mode of the system is manually controlled.

9. The hot water heating system of claim 1, wherein activation of the emergency mode of the system is automatically controlled.

10. A method for supplying water to occupants of a dwelling during an emergency comprising the steps of:
providing a hot water heating system of a dwelling, said hot water system comprising a solar collector, a hot water distribution network, a storage tank and a hot water pipe for collecting water from a relative upper portion of the storage tank to feed said hot water distribution network,
providing a cross-connection pipe that communicates between a relative lower portion of the storage tank and the hot water distribution network, and
activating the hot water heating system to assume an emergency mode by:
opening a flow path for water to exit the relative lower portion of the storage tank via the cross-connection pipe, and
suspending operation of the solar collector to prevent further heating of the water in the storage tank, which would otherwise continue as long as solar radiation reaches the collector.

11. The method of claim 10, wherein the solar collector comprises photovoltaic cells for generating electricity from solar radiation incident on the collector, and the heating of the water in the storage tank is carried out via an electrically activated heating element, and wherein suspending operation of the solar collector comprises shutting off electricity generated by the collar collector from reaching the heating element.

12. The method of claim 10, wherein the system further comprises an outgoing pipe for drawing water from a lower portion of the storage tank towards the solar collector, and water heating is driven by natural convection that circulates water from the tank to the collector and back to the tank, and wherein suspending operation of the solar collector comprises shutting off flow of water through the outgoing pipe towards the solar collector.

13. The method of claim 12, wherein the hot water heating system further comprising an air intake pipe, a cold water pipe and at least one temperature sensor, wherein
the air intake pipe being activated during the emergency mode of the system to open and allow air entry into the storage tank in order to prevent negative pressure within the storage tank, and wherein
the cold water pipe being for refilling the storage tank and comprising a valve that is activated during the emergency mode of the system to close in order to prevent back flow of water via the cold water pipe, and wherein
the at least one sensor being located along the flow path of water exiting the storage tank towards and passed the cross-connection pipe during the emergency mode of the system in order to sense the temperature of the water supplied to the occupants of the dwelling.

14. The method of claim 13, wherein the cross connection pipe comprising a second valve located along said cross-connection pipe in order to limit and/or shut off flow of water passed the cross-connection pipe in response to sensed temperature that is above a certain threshold.

15. The method of claim 10, wherein the cross-connection pipe is located outside and/or inside of the storage tank.
